(19) United States
(12) Patent Application Publication
(10) Pub. No.: US 2007/0242344 A1
(43) Pub. Date: Oct. 18, 2007

(54) COLOR HIGH-RESOLUTION SCANNING DISPLAY SYSTEM

(75) Inventor: Shaoher X. Pan, San Jose, CA (US)

Correspondence Address: FISH & RICHARDSON P.C., PO BOX 1022, MINNEAPOLIS, MN, 55440-1022, US

(73) Assignee: Spatial Photonics, Inc., Sunnyvale, CA (US)

(21) Appl. No.: 11/468,225

(22) Filed: Aug. 29, 2006

Related U.S. Application Data
(63) Continuation-in-part of application No. 11/400,687, filed on Apr. 6, 2006.

(51) Int. Cl. G02B 26/00; G09G 3/00

(52) U.S. Cl. 359/291; 345/32

(57) ABSTRACT

A display system includes one or more rows of tiltable micro mirrors, each of which is configured to be selectively tilted to an “on” position to reflect incident light in an “on” direction and to be selectively tilted to an “off” position to reflect incident light in an “off” direction; an optical projection system configured to project light reflected by the micro mirrors in the “on” direction to produce one or more first lines of image pixels along a first direction in a display image and to change the direction of the light reflected by the micro mirrors in the “on” direction to produce one or more second lines of image pixels in the display image and a light source to produce the incident light. The one or more second lines of image pixels are substantially parallel to the one or more first lines of image pixels.

### CROSS REFERENCES TO RELATED APPLICATIONS

This application is a continuation-in-part of U.S. patent application Ser. No. 11/400,687, titled “High-resolution scanning display system”, filed Apr. 4, 2006, the content of which is incorporated herein by reference.

### BACKGROUND

The present disclosure relates to spatial light modulators.

A micro mirror array is a type of spatial light modulator (SLM) that includes an array of cells, each of which includes a mirror plate that can tilt about an axis and, furthermore, circuitry for generating electrostatic forces that can tilt the micro mirror plate. In a digital mode of operation, for example, the mirror plate can be tilted to stop at two positions. In an “on” position, the micro mirror reflects incident light toward a display surface to form an image pixel in an image display. In an “off” position, the micro mirror directs the incident light away from the image display.

FIG. 1 is a schematic diagram of a conventional display device 100 implementing a two-dimensional (2D) micro mirror array. The display device 100 includes a spatial light modulator 110 mounted on a support plate 115, and a light source system 130. The spatial light modulator 110 includes a 2D array of micro mirrors that tilt to different directions under electronic control. The light source system 130 includes an arc lamp 131, a condenser lens 132, a fold mirror 133, a UV/IR filter 134, a solid light pipe 135, a color wheel 136 mounted on a motor 137, a fold mirror 138, and a relay lens 139. The light emitted from the arc lamp 131 is reflected by a parabolic mirror to produce a collimated light beam 120. The collimated light beam 120 is directed by the condenser lens 132 and reflected by the fold mirror 133. The collimated light beam 120 passes through the UV/IR filter 134, the solid light pipe 135, and then through the spinning color wheel 136. The color wheels include segments of red, green, and blue filters that can alternately filter the collimated light beam 120 to produce different colored light beams 121. The colored light beam 121 is reflected by a fold mirror 138 and then passes through a relay lens 139 to illuminate the micro mirrors in the spatial light modulator 110.

Each micro mirror in the 2D micro mirror array in the light modulator 110 can tilt to an “on” position and an “off” position. The color light beams 140 reflected by the mirrors in the “on” positions are directed toward a display surface to form a two dimensional image. The color light beams 150 reflected by the mirrors in the “off” positions will be absorbed by a light absorber. Each image pixel in the display image is produced by a unique micro mirror in a two dimensional mirror array, that is, a displayed image pixel is correlated with a micro mirror. Thus the number of rows and the number of columns of micro mirrors the 2D micro mirror array are respectively the same as the number of horizontal and vertical image lines in the display image.

### SUMMARY

In a general aspect, the present invention relates to a display system that a spatial light modulator having one or more rows of tiltable micro mirrors, each of which is configured to be selectively tilted to an “on” position to reflect incident light in an “on” direction and to be selectively tilted to an “off” position to reflect incident light in an “off” direction; an optical projection system configured to project light reflected by the micro mirrors in the “on” direction to produce one or more first lines of image pixels along a first direction in a display image and to change the direction of the light reflected by the micro mirrors in the “on” direction to produce one or more second lines of image pixels in the display image; and at least one light source to produce the incident light. The display image is a color display image that is formed by sequentially producing image pixels of different colors.

Implementations of the device may include one or more of the following. The light source can include plurality of light sources, wherein each light source emits colored light and at least two of the light sources produce different colored light from one another. The colored light from a first of the at least one of the light sources can pass through a first beam splitter prior to reaching the spatial light modulator. The colored light from a second of the at least two light sources can be reflected by the first beam splitter prior to reaching the spatial light modulator. The light from the first beam splitter can be directed toward a second beam splitter and colored light from a third light source can also be directed toward the second beam splitter. Light from the second beam splitter can be directed toward the spatial light modulator. The light source can be a white light source and before reaching the optical projection system, the light from the white light source can pass through a color filter.

In another general aspect, the present invention relates to a display system that includes a spatial light modulator having one or more rows of tiltable micro mirrors, where each mirror is configured to be selectively tilted to an “on” position to reflect incident light toward an “on” direction to produce one or more first lines of image pixels along a first direction in a display image and to change the direction of the light reflected by the micro mirrors in the “on” direction to produce one or more second lines of image pixels in the display image, wherein the one or more second lines of image pixels are substantially parallel to the one or more first lines of image pixels; and three light sources that each emit a different colored light from one another to produce the incident light. The display image is a color display image that is formed by producing image pixels of different colors simultaneously.

Implementations of the device may include one or more of the following. The device can have a beam divider or an X-cube, wherein the beam divider or the X-cube is configured to change the direction of the light emitted by at least one light source of the three light sources and to combine the colored light from the three light sources. Each of the three light sources may emit towards a corresponding spatial light modulator, and the light from the three light sources can be directed to the corresponding spatial light modulator prior to reaching the beam divider or the X-cube. The colored light from the three light sources can reach the spatial light modulator simultaneously. The three light sources can include a red light source, a blue light source and a green light source. A subset of the wavelengths of the light from at least one light source can be divided out prior to the reflected incident light reaching the optical projection system. The device can have a beam divider, which redirects the light toward a spatial light or which redirects the light toward the optical projection system. The device can have a corresponding spatial light modulator for each of the three light sources, wherein the colored light is reflected by the corresponding spatial light modulator towards the beam divider. The device can have a transport mechanism configured to rotate the projection device to change the direction of the light reflected by the micro mirrors in the “on” direction to a plurality of directions such that a plurality of sets of one or more second lines of image pixels are formed substantially parallel to the one or more first lines of image pixels. Each micro mirror may be configured to be tilted by an electrostatic force about an axis substantially perpendicular to the row direction of the one or more rows of tiltable micro mirrors.

The details of one or more embodiments of the invention are set forth in the accompanying drawings and the description below. Other features, objects, and advantages of the invention will be apparent from the description and drawings, and from the claims.

### DESCRIPTION OF DRAWINGS

The following drawings, which are incorporated in and form a part of the specification, illustrate embodiments of the present invention and, together with the description, serve to explain the principles, devices and methods described herein.

FIG. 1 is a schematic diagram of a conventional display system.

FIG. 2a is a schematic view, partially perspective and partially block diagram, of a scanning display system.

FIGS. 2b-2c are a schematic side view of the scanning display system.

FIGS. 3a-3d are detailed views of the one implementations of the spatial light modulator compatible with the scanning display system of FIG. 2a.

FIG. 4 is an exemplified cross-section view of a micro mirror along the line A-A in FIG. 3a.

FIGS. 5 and 6 illustrate arrangements for providing colored light sources for a spatial light modulator.

FIGS. 7 and 8 illustrate arrangements for providing colored light sources and corresponding spatial light modulators.

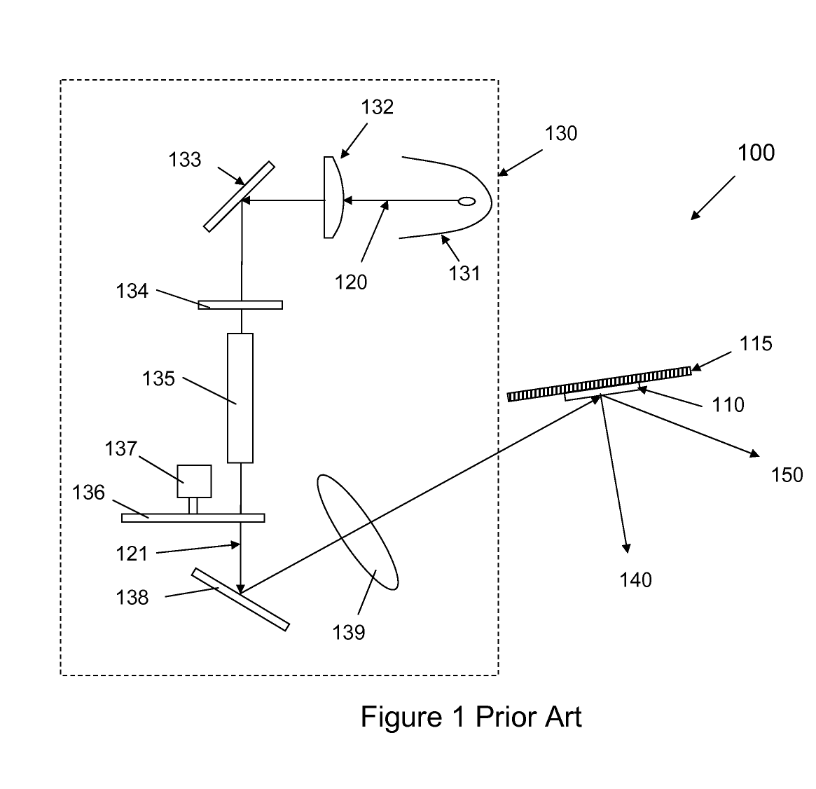

Like reference symbols in the various drawings indicate like elements.

### DETAILED DESCRIPTION

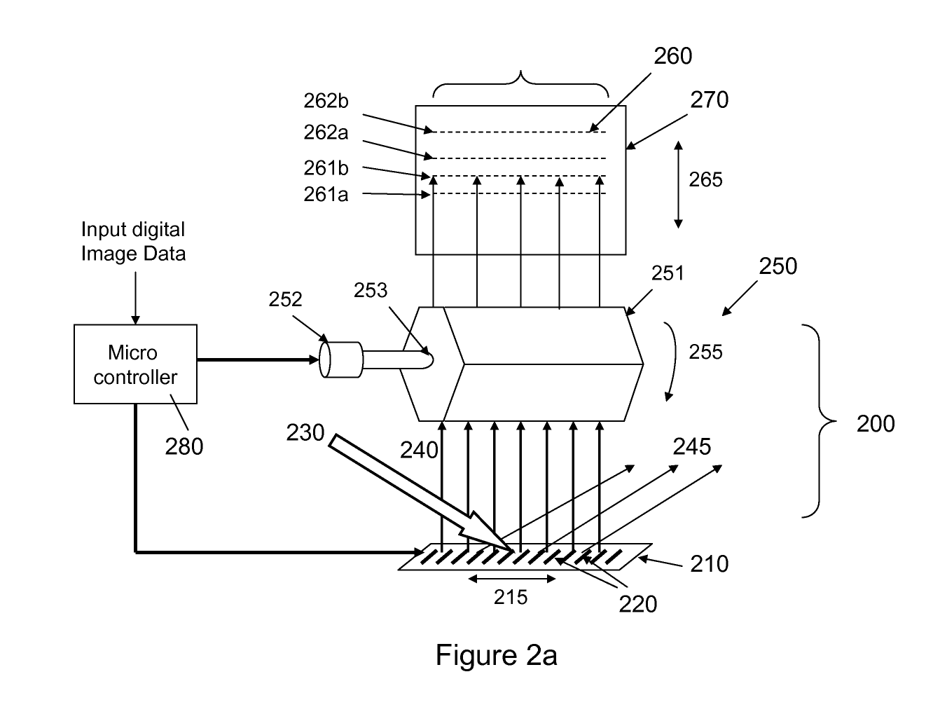

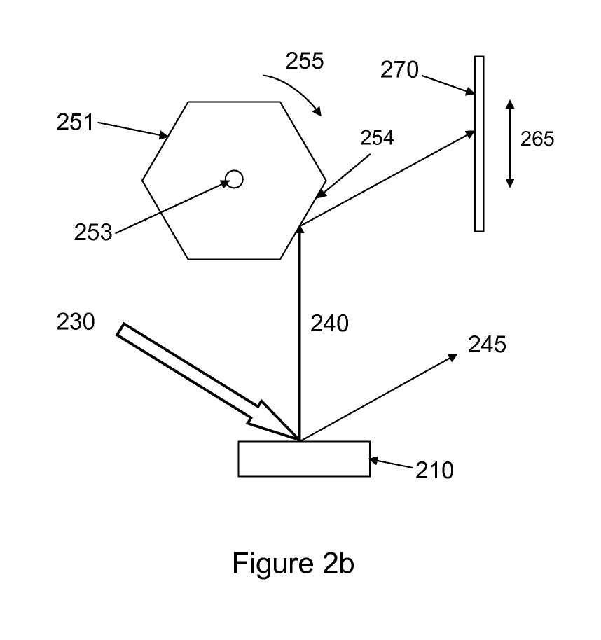

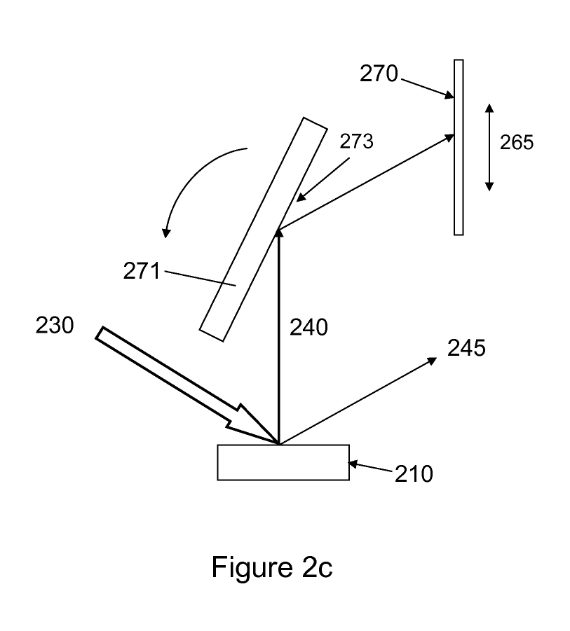

FIG. 2a is a schematic view, partially perspective and partially block diagram, of a scanning display system 200. FIG. 2b is a schematic side view of the scanning display system 200. The scanning display system 200 includes a spatial light modulator 210 and an optical projection system 250. The spatial light modulator 210 includes a plurality of tiltable micro mirrors 220 that are distributed in one or more rows along a lateral direction 215. The spatial light modulator 210 typically includes a small number of rows (for example, less than 10 rows) of tiltable micro mirrors 220. In particular, the number of rows of micro mirrors in the spatial light modulator 210 is much smaller than the number of rows of pixels in a typical display image to be produced by the scanning display system 200.

As described in more detail below, the tiltable mirrors 220 can be individually addressed to tilt in two or more directions by a micro controller 280. The micro mirrors 220 can tilt to the “on” positions to reflect incident light 230 to produce reflected light 240 in the “on” direction. Alternatively, the incident light 230 can be directed by the micro mirrors 220 in the “off” positions to produce reflected light 245 in the “off” direction. The light 245 can subsequently be absorbed by a light absorber (not shown) to prevent flare light. The incident light 230 can be produced by various light sources, such as a light emitting diode (LED) or an arc lamp.

The micro controller 280 receives input image data, such as video data including a series of image frames. The micro controller 280 controls the orientations of the tiltable micro mirrors 220 to the “on” or “off” positions in accordance with the pixel values at a line of image pixels in the input digital image. The light 240 reflected by the “on” micro mirrors 220 is projected by the optical projection system 250 to a display area 270. The display area 270 can, for example, be on a projection screen, a white board, a glass pane, a wall, or a virtual image. The projected light forms a line of image pixels 261a on the display area 270 in accordance with the pixel values in a line of image pixels in the input digital image.

In one implementation, the optical projection system 250 includes a polygon 251 that includes one or more reflective flat surfaces 254. The flat polygon surfaces 254 can reflect the light 240 toward a display area 270 to form an image on the display area 270. The polygon 251 can be made of glass, metal, or plastic. The polygon surfaces 254 can be coated with a thin layer of reflective metal such as aluminum. The polygon surfaces 254 are required to be flat within a tolerance such that the image pixels can be formed uniformly on the display area 270. For example, one criterion for the flatness of the polygon surfaces 254 is that the distortions of image pixel locations in the displayed image on the display area 270 should be less than ½ the width of an image pixel. Another criterion on the roughness of the polygon surfaces 254 should be smaller than one or a fraction of a wavelength of visible light over the illuminated area of a polygon surface 254.

The optical projection system 250 also includes a transport mechanism 252 that can rotate the polygon 251 about a rotational axis 253. In one implementation, the transport mechanism 252 includes a motor that is under the control of the micro controller 280. The motor can be a DC motor or a digital stepper motor. The micro controller 280 controls the transport mechanism 252, which in turn rotates the polygon 251 about the rotational axis 253 in synchronization with the modulation of the micro mirrors 220. The rotated polygon 251 changes the directions of the light reflected by the polygon 251, such that the light projected onto the display area 270 is scanned along a vertical direction 265. In one implementation, the rotational axis 253 of the polygon 251 can be substantially perpendicular to the vertical direction 265 and substantially parallel to the lines of image pixels 261a, 261b, 262a, and 262b. In some implementations, the polygon 251 rotates in a single direction, such as clockwise 255 or counterclockwise.

As the polygon 251 rotates through different angular positions, the micro controller 280 controls the micro mirrors 220 to the “on” or “off” positions in accordance with corresponding pixel values at a horizontal line of image pixels in the input digital image. At one angular position, the micro mirror can form a line of image pixels 261a in the display area 270. However, as the polygon 251 rotates to different angular positions, different lines of image pixels 261b, 262a, 262b, etc., are formed in the display area 270. The lines of image pixels 261a can be formed in progressive or interlaced fashion. The lines of image pixels 261a, 261b, 262a and 262 can together form a 2D display image 260 in the display area 270.

Referring to FIG. 2c, a rotating mirror 271 can be used in place of the polygon 251. The mirror 271 has a reflective surface 273 onto which the reflected light 240 is directed. The mirror rotates back and forth, such as along an axis of rotation or along the mirror or outside of the mirrors surface.

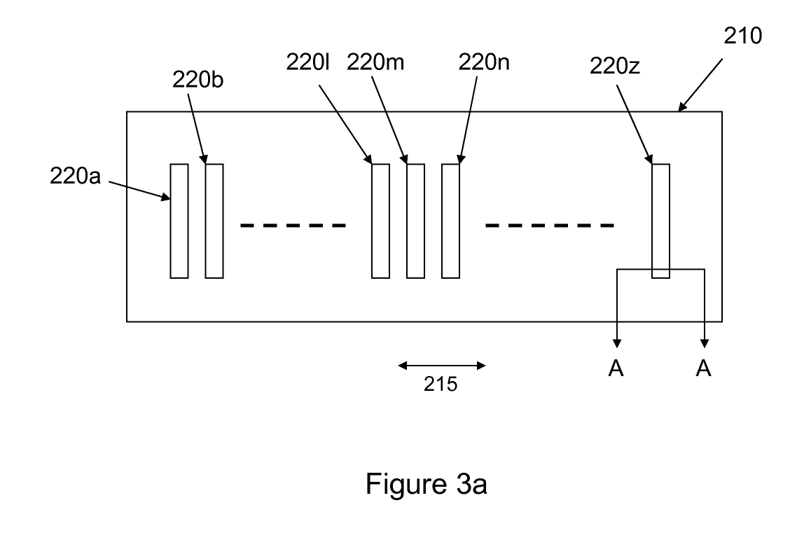

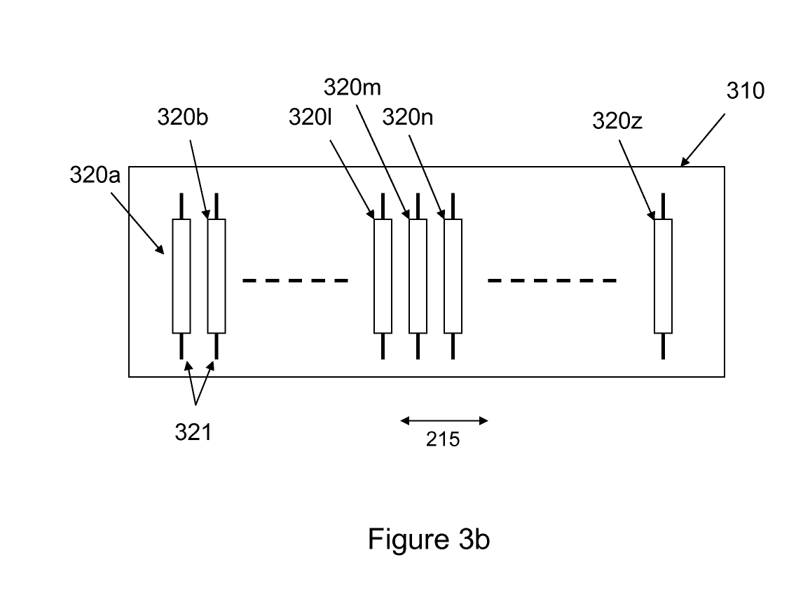

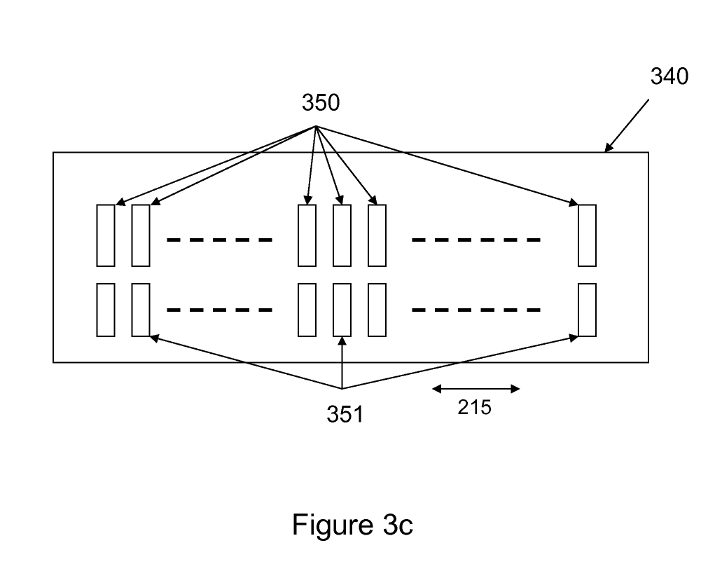

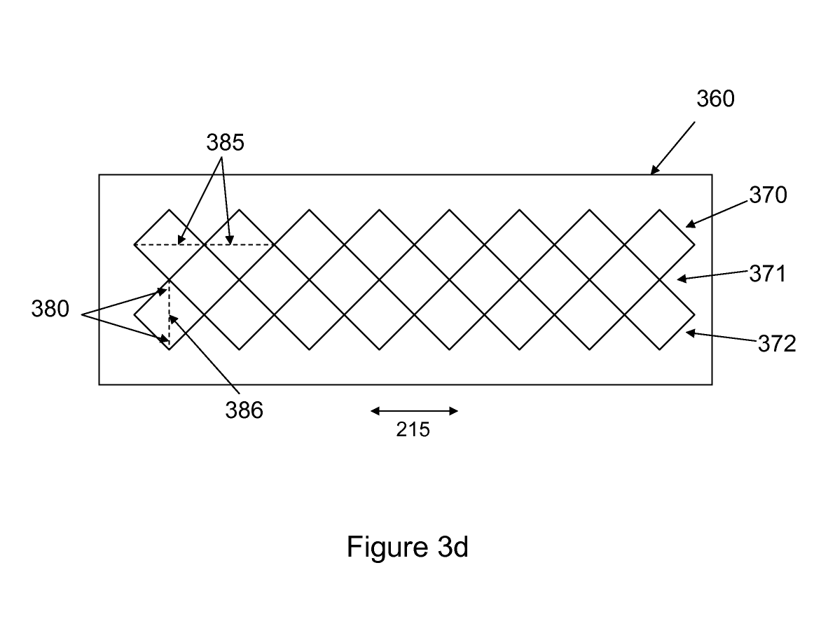

FIG. 3a is a detailed view of an example of the spatial light modulator 210 compatible with the scanning display system 200. The spatial light modulator 210 includes a plurality of micro mirrors 220a to 220z distributed in one dimensional (1D) array along the lateral direction 215. In one implementation, the micro mirrors 220a-220z are rectangular shaped, with their widths narrower than their lengths. The narrow dimensions of the micro mirrors 220a-220z are aligned along the lateral direction 215 to maintain a high density of micro mirrors 220a-220z in the spatial light modulator 210 (which enables the formation of a high resolution display image in the display area 270). The long dimensions of the micro mirrors 220a-220z increase the mirror areas and thus the amount of the light reflected by the micro mirrors 220a-220z.

The micro mirrors 220a-220z can be hinged at hinges (not shown) at the ends of the long dimensions of the mirrors. The hinges act as pivot points that define rotational axes for the micro mirrors' tilt movements. In one implementation, as shown in FIG. 3a, the hinges are hidden under the mirror plates. In another implementation, as shown in FIG. 3b, the hinges 321 for the micro mirrors 320a-320z in the spatial modulator 310 are at least partially exposed outside of their respective mirror plates.

In another implementation, shown in FIG. 3c, the spatial light modulator 340 includes two rows of micro mirrors 350 and 351, both distributed in the lateral direction 215. The micro mirrors 350 and 351 can be rectangular, square, or of other shapes. The hinges (not shown) can be hidden as shown in FIG. 3c or exposed. The spatial light modulator 340 is capable of simultaneously displaying two lines of image pixels 261a and 261b on the display surface 270 at each projected direction by the polygon 251. As the polygon 251 rotates to a different angular direction, the polygon 251 directs the light 240 to the display surface 270 to form two different lines of image pixels 262a and 262b. To avoid smearing between adjacent lines of image pixels, the polygon 251 can be rotated by a stepper motor. The polygon 251 can be held for a short line time for forming each pair of image pixel lines. When the polygon 251 rotates from one angular position to the next angular position, the incident line 230 can briefly be deflected away for the display surface 270 to produce light 245.

In yet another implementation, FIG. 3d depicts an example of a spatial light modulator 360 that includes three rows of micro mirrors 370, 371, and 372 that are distributed in the lateral direction 215. The micro mirrors 370, 371, and 372, as shown, have diamond or square shapes. One diagonal line 385 of a micro mirror 370, 371, or 372 is parallel to the lateral direction 215. The hinges 380 of the micro mirror can be located at two opposite corners of the diamond-shaped or square-shaped micro mirror. The hinges 380 act as pivot points for the micro mirror 370, 371 or 372 to allow the mirror plate to tilt about an axis 386 defined by the two hinges 380. In the configuration shown in FIG. 3d, the axes of rotation for the micro mirrors 370, 371 or 372 are perpendicular to the lateral direction 215.

An example of the operation of the scanning display system 200 is now described. The spatial light modulator 210 can include 4000 micro mirrors in a 1D mirror array as shown in FIG. 3a. Thus each image line 261a, 261b, 262a or 262b includes 4000 image pixels. Each of the image lines 261a, 261b, 262a and 262 corresponds to a particular reflective orientation of the polygon 251. The scanning display system 200 can be configured to provide a display image that is 4000 pixels wide and 2000 pixels high in the display area 270. To provide a monochrome video display at a bit depth of 8 bits and a frame rate of 60 Hz, the shortest “on” time for a micro mirror (also referred as Least Significant Bit) is

LSB=1/((bit depth)×(frame rate)×(number of color planes)×(number of image rows))=1/(256×60 Hz×2000)=0.003 micro second. Eqn. (1)

To provide a color video display at the same conditions, the shortest “on” time for a micro mirror is thus 0.011 micro second.

In another example of the operation of the scanning display system 200, the spatial light modulator 210 as shown in FIG. 3d includes three rows of 4000 micro mirrors. The scanning display system 200 can be configured to produce a display image that is 4000 pixels wide and 2000 pixels high. Three lines of image pixels can be simultaneously displayed by the three rows of micro mirrors 370, 371, and 372. To provide a monochrome video display at a bit depth of 8 bits and a frame rate of 60 Hz, the shortest “on” time for a micro mirror is

LSB=1/((bit depth)×(frame rate)×(number of color planes)×(number of image rows)/(number of mirror rows))=1/(256×60 Hz×2000/3)=0.1 micro second. Eqn. (2)

Similarly, to provide a color video display using the three rows of mirrors and otherwise the same conditions, the shortest “on” time for a micro mirror is thus 0.033 micro second. The requirement on the rates of the mirror tilt movement is relaxed compared to the spatial light modulator shown in FIG. 3a.

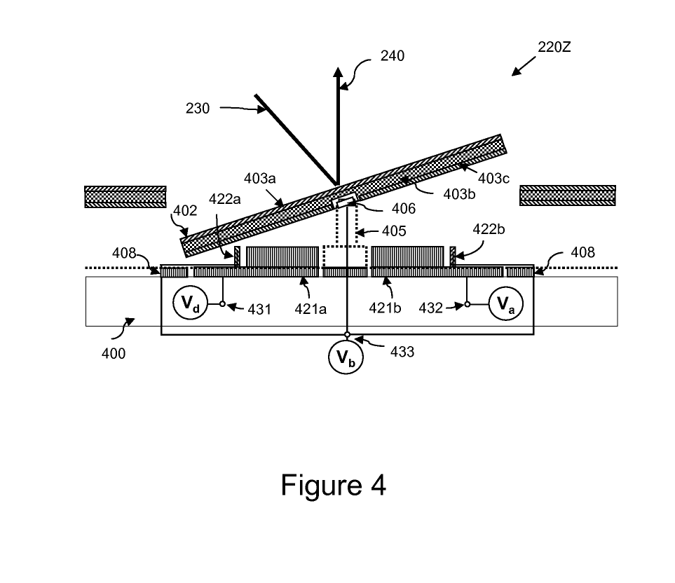

FIG. 4 illustrates an exemplified detailed structure for the micro mirror 220Z. In a cross-sectional view along line A-A in FIG. 3a, the micro mirror 220Z includes a mirror plate 402 that includes a flat reflective upper layer 403a that provides the mirror surface, a middle layer 403b that provides the mechanical strength to the mirror plate, and a bottom layer 403c. The upper layer 403a can be realized by a reflective material, typically, a thin reflective metallic layer. For example, aluminum, silver, or gold can be used to form the upper layer 403a. The layer thickness can be in the range of 200 to 1000 angstroms, such as about 600 angstroms. The middle layer 403b can be made of a silicon based material, for example, amorphous silicon, typically about 2000 to 5000 angstroms in thickness. The bottom layer 403c can be built by an electrically conductive material that allows the electric potential of the bottom layer 403c to be controlled relative to the step electrodes 421a or 421b. For example, the bottom layer 403c can be made of titanium and has a thickness in the range of 200 to 1000 angstrom.

The mirror plate 402 includes a hinge 406 that is connected with the bottom layer 403c and is supported by a hinge post 405 that is rigidly connected to a substrate 400. The mirror plate 402 can include two hinges 406 (i.e., hinge 221 in FIG. 3a) connected to the bottom layer 403c. Each hinge 406 (or 221) defines a pivot point for the mirror plate 402. The two hinges 406 (or 221) define an axis about which the mirror plate 402 can be tilted. The hinges 406 extend into cavities in the lower portion of mirror plate 403. For ease of manufacturing, the hinge 406 can be fabricated as part of the bottom layer 403c.

Step electrodes 421a and 421b, landing tips 422a and 422b, and a support frame 408 can also be fabricated over the substrate 400. The step electrode 421a is electrically connected to an electrode 431 whose voltage Vd can be externally controlled. Similarly, the step electrode 421b is electrically connected with an electrode 432 whose voltage Va can also be externally controlled. The electric potential of the bottom layer 403c of the mirror plate 402 can be controlled by electrode 433 at potential Vb.

The micro mirror 220Z can be selectively controlled from the group of micro mirrors 220a to 220z. Bipolar electric pulses can individually be applied to the electrodes 431, 432, and 433. Electrostatic forces can be produced on the mirror plate 402 when electric potential differences are created between the bottom layer 403c on the mirror plate 402 and the step electrodes 421a or 421b. An imbalance between the electrostatic forces on the two sides of the mirror plate 402 causes the mirror plate 402 to tilt from one orientation to another. When the mirror plate 402 is tilted to the “on” position as shown in FIG. 4, the flat reflective upper layer 402 reflects the incident light 230 to produce the reflected light 240 along the “on” direction. The incident light 230 is reflected to the “off” direction when the mirror plate 402 is tilted to the “off” position.

The multiple steps in the step electrodes 421a and 421b narrow the air gap between the mirror plate 403 and the electrodes 421a or 421b, and can increase the electrostatic forces experienced by the mirror plate 402. The height of the step electrodes 421a and 421b can be in the range from about 0.2 microns to 3 microns.

The landing tips 422a and 422b can have a same height as that of second step in the step electrodes 421a and 421b for manufacturing simplicity. The landing tips 422a and 422b provide a gentle mechanical stop for the mirror plate 402 after each tilt movement. The landing tips 422a and 422b can also stop the mirror plate 402 at a precise angle. Additionally, the landing tips 422a and 422b can store elastic strain energy when they are deformed by electrostatic forces and convert the elastic strain energy to kinetic energy to push away the mirror plate 402 when the electrostatic forces are removed. The push-back on the mirror plate 402 can help separate the mirror plate 402 and the landing tips 422a and 422b, which helps to overcome the stiction of the mirror plate to the substrate, a well known challenge for micro mirror devices.

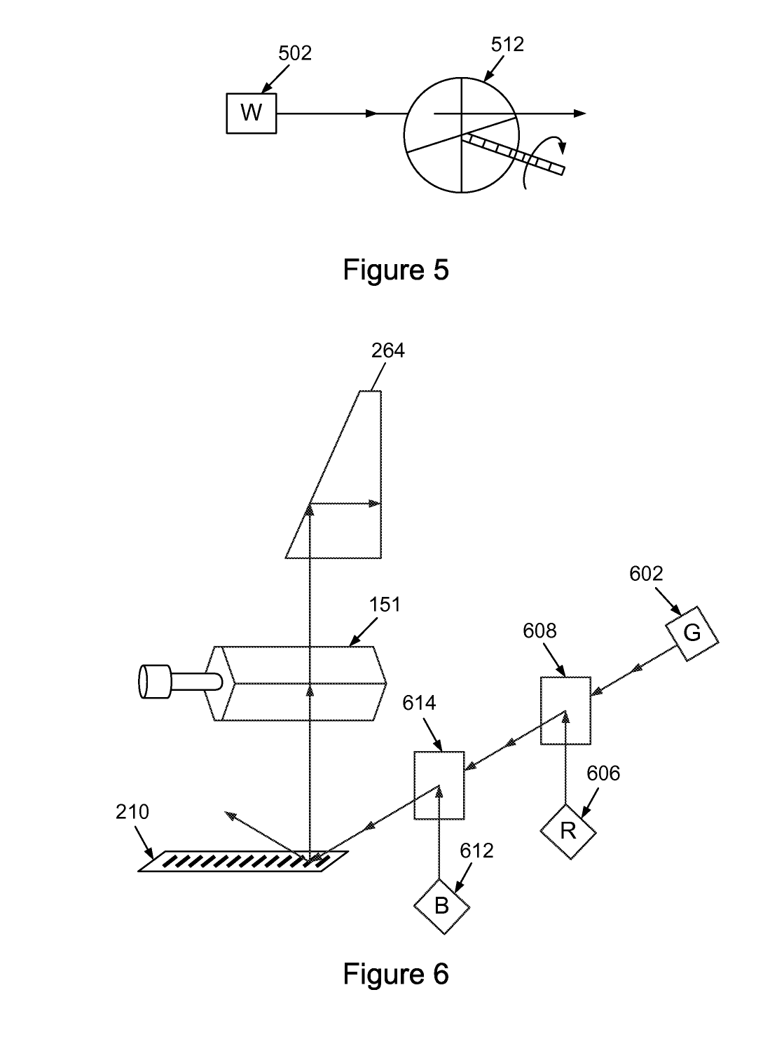

FIGS. 5 illustrates an arrangement for providing a colored light source for a spatial light modulator compatible with the scanning display system 200. A white light source 502 emits light 555 that comprises a wide spectrum of wavelengths, such as between about 400 nm and 700 nm. In some embodiments, white light is created by combining different colored lights (e.g. red, green, and blue lights). An example of the white light source 502 is a tungsten light. The light 550 passes through color filters on a spinning color wheel 512. The color wheel 512 can include a plurality of color filters arranged in different angular segments. For example, the color wheel can include six red (R), green (G), and blue (B) color filters sequenced in R, G, B, R, G, and B. After the light 550 passes through the spinning color wheel 512, the light becomes the incident light 230 which will eventually fall upon the micro mirrors 220 of the display system 200. As the color wheel 512 spins, the incident light 550 sequentially alternates colors in a series of image frames each for producing a single color pixel in a display image. Where a single color is referred to, the single color can include a number of wavelengths that together appear as a color, such as green, red or blue, to an observer. The tiltable micro mirrors in the spatial light modulator 210 can be selectively tilted to direct the colored incident light 550 to form color pixels in the display image. The selective tilting of the micro mirrors is driven by the input digital image data in the color plane that corresponds to color of the incident light. A computer can synchronize the timing of the color incident light 230 and the input image data of the associated color plane for tilting the tiltable mirrors in the spatial light modulator 210.

FIG. 6 illustrates another arrangement for providing colored light to the spatial modulator 210. A red light source 602, green light source 606, and blue light source 612 can respectively emit red light 603, green light 607, and blue light 613. The red light source 602, green light source 606, and blue light source 612 can be based on light emitting diode (LED) or semiconductor lasers. The red light 603 or the green light 607 can be input to a beam divider 608 (which in this case acts as a beam combiner) to produce light 609. The beam divider 608 can allow the light beam (i.e. the red light 603) received on one surface to pass through while reflecting another light beam (i.e. the green light 607) received on the opposite surface. The red light source 602 and green light source 606 are controlled such that either red light 603 or the green light 607 is input to the beam divider 608 at any given time. The light 609 is thus is either red or green at any given time. Similarly, light 609 and the blue light 613 are input to a beam divider 614 that can be controlled to output the incident light 230. The blue light source 612 is controlled such that either the light 609 (red or green) or the blue light 613 is input to the beam divider 614 at any given time. By properly controlling the red light source 602, green light source 606, and blue light source 612, a single color incident light 230 (red, green, or blue) can sequentially illuminate the spatial light modulator 210. The tiltable micro mirrors in the spatial light modulator 210 can be selectively tilted to direct the colored incident light 230 to form color pixels in the display image. The color wheel 512 can alternatively be placed after the micro mirrors 220 of the display system. The selective tilting of the micro mirrors is driven by the input digital image data in the color plane that corresponds to color of the incident light. A computer can synchronize the timing of the color incident light 230 and the input image data of the associated color plane for tilting the tiltable mirrors in the spatial light modulator 210.

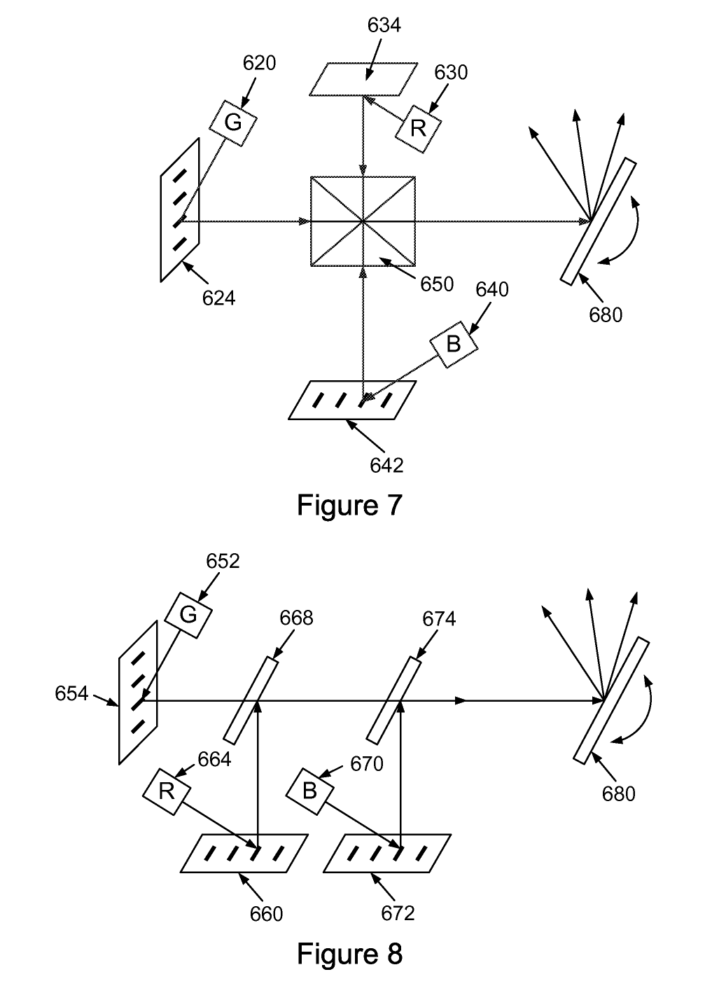

FIGS. 7 and 8 illustrate other arrangements for providing colored light sources for the scanning display system 200. Unlike the arrangements shown in FIGS. 5 and 6, separate spatial modulators are provided for producing different color pixels of the display image. In FIG. 7, tiltable mirrors in a spatial light modulator 634 can selectively reflect the red light emitted from the red light source 630 to produce spatially modulated red light 635. Tiltable mirrors in a spatial light modulator 624 can selectively reflect the green light emitted from the green light source 620 to produce spatially modulated green light 625. Tiltable mirrors in a spatial light modulator 644 can selectively reflect the blue light emitted from the blue light source 640 to produce spatially modulated blue light 645. The spatial light modulators 624, 634, and 644 can each include a plurality of tiltable mirrors distributed in one or more rows. The spatially modulated single color light (625, 635, and 645) is combined by an X-Cube 650 to produce the multi-colored incident light 130. The X-Cube 650 includes two diagonal single-pass interfaces to allow the modulated green light 625 to pass through and the modulated red light 635 and the modulated blue light 645 to be reflected. The modulated colored light (625, 635, and 645) merges to form the incident light 230. The spatially modulated incident light 230 is directed by a rotating mirror 680 (or a polygon) to form a color display image. In contrast to the sequential color modulations shown in FIGS. 5 and 6, different colored light can be directed simultaneously by the three spatial light modulators 624, 634, and 644.

Similar to the arrangement shown in FIG. 7, the red, green, and blue light is respectively emitted from red light source 664, the green light source 652, and the blue light source 670 as shown in FIG. 8. The red, green, and blue light is further selectively reflected respectively by the tiltable mirrors in spatial light modulators 660, 654, and 672 to produce spatially modulated color light 655, 665, and 675. The spatially modulated single-color light 655, 665, and 675 is combined by beam dividers 668 and 674 to produce spatially modulated multi-color incident light 230. The spatially modulated incident light 230 is directed by a rotating mirror 680 (or a polygon) to form a color display image. An advantage of the arrangements shown in FIGS. 7 and 8 is that different color pixels can be formed simultaneously in the display image, which can provide higher display frame rate in video image display, or relax the response rates required for the micro mirrors in the spatial light modulators.

It is understood that the disclosed systems and methods are compatible with other configurations of micro mirrors, optical scanning and projection systems, and displays without deviating from the spirit of the present invention. The micro mirrors can generally include mirrors that are made by micro-fabrication techniques and can tilt in one or more orientations under electronic control. Different light sources can be used by the disclosed display system. In addition, the parameters used above are meant to be examples for illustrating the operations of the disclosed display system. The disclosed display system can operate at different operating conditions without deviating from the spirit of the present specification. Furthermore, although FIG. 4 shows an example of a mirror plate that stop at pre-determined angles by contacting the landing tips, the disclosed display system is also compatible with non-contact micro mirrors that can tilt to different positions without contacting an object on the substrate.

It should also be understood that the display image discussed in relation with in FIGS. 2a and 2b can be aligned in different orientations relative to the viewers. For example, the disclosed display system can be configured such that the display image is 2000 pixels wide and 4000 pixels high. Furthermore, the light modulated by the spatial light modulator based on one or more rows of micro mirrors can be scanned by optical systems other than the polygon, as shown in FIGS. 2a and 2b.

A number of embodiments of the invention have been described. Nevertheless, it will be understood that various modifications may be made without departing from the spirit and scope of the invention. Feature of any of the disclosed embodiments can be used with other embodiments and different embodiments do not have features that are exclusive of being used with the other embodiments. Accordingly, other embodiments are within the scope of the following claims.

What is claimed is:

1. A display system, comprising:
a spatial light modulator having one or more rows of tiltable micro mirrors, wherein each micro mirror is configured to be selectively tilted to an “on” position to reflect incident light in an “on” direction and to be selectively tilted to an “off” position to reflect incident light in an “off” direction;
an optical projection system configured to project light reflected by the micro mirrors in the “on” direction to produce one or more first lines of image pixels along a first direction in a display image and to change the direction of the light reflected by the micro mirrors in the “on” direction to produce one or more second lines of image pixels in the display image, wherein the one or more second lines of image pixels are substantially parallel to the one or more first lines of image pixels; and
at least one light source to produce the incident light;
wherein the display image is a color display image that is formed by sequentially producing image pixels of different colors.

2. The display system of claim 1, wherein the at least one light source includes a plurality of light sources, wherein each light source emits colored light and at least two of the light sources produce different colored light from one another.

3. The display system of claim 2, wherein the colored light from a first of the at least one of the light sources passes through a first beam splitter prior to reaching the spatial light modulator.

4. The display system of claim 3, wherein the colored light from a second of the at least two light sources is reflected by the first beam splitter prior to reaching the spatial light modulator.

5. The display system of claim 4, wherein the light from the first beam splitter is directed toward a second beam splitter and colored light from a third light source is also directed toward the second beam splitter.

6. The display system of claim 5, wherein light from the second beam splitter is directed toward the spatial light modulator.

7. The display system of claim 1, wherein the at least one light source is a white light source and before reaching the optical projection system, the light from the white light source passes through a color filter.

8. A display system, comprising:
a spatial light modulator having one or more rows of tiltable micro mirrors, wherein each micro mirror is configured to be selectively tilted to an “on” position to reflect incident light in an “on” direction and to be selectively tilted to an “off” position to reflect incident light in an “off” direction;
an optical projection system configured to project light reflected by the micro mirrors in the “on” direction to produce one or more first lines of image pixels along a first direction in a display image and to change the direction of the light reflected by the micro mirrors in the “on” direction to produce one or more second lines of image pixels in the display image, wherein the one or more second lines of image pixels are substantially parallel to the one or more first lines of image pixels; and
three light sources that each emit a different colored light from one another to produce the incident light;
wherein the display image is a color display image that is formed by producing image pixels of different colors simultaneously.

9. The display system of claim 8, further comprising a beam divider or an X-cube, wherein the beam divider or the X-cube is configured to change the direction of the light emitted by at least one light source of the three light sources and to combine the colored light from the three light sources.

10. The display system of claim 9, wherein each of the three light sources emit towards a corresponding spatial light modulator, and the light from the three light sources is directed to the corresponding spatial light modulator prior to reaching the beam divider or the X-cube.

11. The display system of claim 8, wherein the colored light from the three light sources reaches the spatial light modulator simultaneously.

12. The display system of claim 8, wherein the three light sources include a red light source, a blue light source and a green light source.

13. The display system of claim 8, wherein a subset of the wavelengths of the light from at least one light source are divided out prior to the reflected incident light reaching the optical projection system.

14. The display system of claim 8, further comprising a beam divider, which redirects the light toward a spatial light modulator.

15. The display system of claim 8, further comprising a beam divider, which redirects the light toward the optical projection system.

16. The display system of claim 15, further comprising a corresponding spatial light modulator for each of the three light sources, wherein the colored light is reflected by the corresponding spatial light modulator towards the beam divider.

17. The display system of claim 8, further comprising a transport mechanism configured to rotate the projection device to change the direction of the light reflected by the micro mirrors in the “on” direction to a plurality of directions such that a plurality of sets of one or more second lines of image pixels are formed substantially parallel to the one or more first lines of image pixels.

18. The display system of claim 8, wherein each micro mirror is configured to be tilted by an electrostatic force about an axis substantially perpendicular to the row direction of the one or more rows of tiltable micro mirrors.
